(19) United States
(12) Patent Application Publication
(10) Pub. No.: US 2026/0025861 A1
(43) Pub. Date: Jan. 22, 2026

(54) SYSTEM AND METHOD FOR MANAGING RRC SETUP TIME WITH A SCHEDULING REQUEST GRANT

(71) Applicant: JIO PLATFORMS LIMITED, Ahmedabad, Gujarat (IN)

(72) Inventors: Sairambabu N L KANCHARLAPALLI, Bengaluru, Karnataka (IN); Srinivasa Vundavilli RAO, Bangalore, Karnataka (IN); Yashesh BUCH, Navi Mumbai, Maharashtra (IN); Kakarla Vamsi KRISHNA, Chennai, Tamil Nadu (IN); Ullas K N, Tumakuru, Karnataka (IN); Aayush BHATNAGAR, Navi Mumbai, Maharashtra (IN); Pradeep Kumar BHATNAGAR, Navi Mumbai, Maharashtra (IN)

(73) Assignee: JIO PLATFORMS LIMITED, Ahmedabad, Gujarat (IN)

(21) Appl. No.: 18/993,032

(22) PCT Filed: May 2, 2024
(86) PCT No.: PCT/IN2024/050470

§ 371 Date: Jan. 10, 2025

(30) Foreign Application Priority Data
May 30, 2023 (IN) 202321037377

(51) Int. Cl. H04W 76/10; H04L 1/00; H04L 1/1812; H04W 72/21; H04W 72/23; H04W 72/54; H04W 74/0833

(52) U.S. Cl. CPC H04W 76/10; H04L 1/0003; H04L 1/0009; H04L 1/1812; H04W 72/21; H04W 72/23; H04W 72/54; H04W 74/0833

(57) ABSTRACT

The present disclosure provides a system and a method for managing radio resource control (RRC) setup time with a scheduling request grant. The system allocates the required resources for message transmission from a user equipment (UE) (302) and sends a grant proactively, without waiting for a scheduling request (SR) from the UE (302) and allocates resources. The proactive grant with the SR reduces the delay associated with the RRC connection setup time. Further, the system allocates resource blocks (RBs) based on a learned uplink (UL) channel signal interference and noise ratio (SINR) characteristics.

### RESERVATION OF RIGHTS

A portion of the disclosure of this patent document contains material, which is subject to intellectual property rights such as but are not limited to, copyright, design, trademark, integrated circuit (IC) layout design, and/or trade dress protection, belonging to Jio Platforms Limited (JPL) or its affiliates (hereinafter referred as owner). The owner has no objection to the facsimile reproduction by anyone of the patent document or the patent disclosure, as it appears in the Patent and Trademark Office patent files or records, but otherwise reserves all rights whatsoever. All rights to such intellectual property are fully reserved by the owner.

### FIELD OF INVENTION

The present disclosure generally relates to systems and methods for managing radio resource control (RRC) set up time. More particularly, the present disclosure relates to a system and a method for managing RRC setup time with a scheduling request (SR) grant.

### BACKGROUND OF THE INVENTION

The following description of the related art is intended to provide background information pertaining to the field of the disclosure. This section may include certain aspects of the art that may be related to various features of the present disclosure. However, it should be appreciated that this section is used only to enhance the understanding of the reader with respect to the present disclosure, and not as admission of the prior art.

Conventionally, after receiving a message at a base station, a radio resource management (RRM) at a distributed unit (DU) allocates physical uplink control channel (PUCCH) resources corresponding to a scheduling request (SR) and channel state information (CSI) to a user equipment (UE). The DU sends a medium access control (MAC) control element (CE) with a contention resolution identity. After a hybrid automatic repeat request (HARQ) acknowledgement feedback is received for the contention resolution MAC CE, the DU scheduler schedules a downlink (DL) radio resource control (RRC) message transfer to forward the RRC setup message using the DL common control channel (CCCH) message to the UE. The DU receives the HARQ acknowledgement for the RRC setup message sent. The UE, after receiving the RRC setup message, waits for the SR opportunity to send the SR to get the grant for the message sent. To transmit the message, minimum resource blocks, and a minimum modulation and coding scheme, multiple radio link control (RLC) level retransmissions may be observed at the UE. Hence, in order to receive a complete upper layer packet, this process may lead to an RRC setup timeout at the base station. Therefore, with the current implementation, a significant delay may be noticed, which leads to performance degradation issues and wastage of resources. Henceforth, with the presently available process, there is a significant delay in UE getting connected to the network, leading to network performance degradation.

There is, therefore, a need in the art to provide a system and a method that can mitigate the problems associated with the prior arts.

### OBJECTS OF THE INVENTION

It is an object of the present disclosure to provide a system and a method that improves initial uplink (UL) message transmission timing by scheduling a proactive grant through channel aware scheduling which in turn reduces the radio resource control (RRC) connection setup time.

It is an object of the present disclosure to provide a system and a method that upon receiving an acknowledgement for a downlink (DL) common control channel (CCCH) message, provides a grant to transmit the message that reduces the RRC connection setup time.

It is an object of the present disclosure to provide a system and a method that schedules uplink modulation and coding scheme (MCS) and resource blocks (RBs) based on the learned UL channel signal interference and noise ratio (SINR) characteristics.

It is an object of the present disclosure to optimize time to setup a call.

It is an object of the present disclosure to enhance the user experience.

It is an object of the present disclosure to improve the communication system.

### SUMMARY

In an exemplary embodiment, the present invention discloses a method for managing radio resource control (RRC) setup time with a scheduling request (SR) grant. The method comprising sending, by a distributed unit (DU), a random access response (RAR) to a user equipment (UE) after receiving a random access channel (RACH) request. The method comprising receiving, at the DU, a RRC set up request from the UE. The method comprising sending, by the DU, an initial uplink (UL) RRC message to a centralized unit (CU). The method comprising sending, by the DU, a medium access control (MAC) control element (CE) to the UE. The method comprising sending, by the CU, a downlink (DL) RRC message to the DU. The method comprising receiving, at the DU, a hybrid automatic repeat request (HARQ) feedback message from the UE. The method comprising sending, by the DU, a DL common control channel (CCCH) message to the UE. The method comprising receiving, at the DU, an uplink control information (UCI) indication message from the UE. The method comprising sending, by the DU, the scheduling request (SR) grant with modulation and coding scheme (MCS) and resource blocks (RBs) to the UE. The method comprising receiving, at the DU, a RRC setup complete message from the UE.

In some embodiments, the method further comprising sending, by the distributed unit an UL RRC complete message to the CU.

In some embodiments, the method further comprising allocating a plurality of physical uplink control channel (PUCCH) resources to the UE after receiving the RRC set up request.

In some embodiments, a size of the MCS and a number of the RBs is determined based on an uplink (UL) signal to noise ratio (SINR).

In an exemplary embodiment, the present invention discloses a system for managing radio resource control (RRC) setup time with a scheduling request (SR) grant. The system is configured to send, by a distributed unit (DU), a random access response (RAR) to a user equipment (UE) after receiving a random access channel (RACH) request. The system is configured to receive, at the distributed unit, a RRC set up request from the UE. The system is configured to send, by the distributed unit, an initial uplink (UL) RRC message to a centralized unit (CU). The system is configured to send, by the distributed unit, a medium access control (MAC) control element (CE) to the UE. The system is configured to send, by the CU, a downlink (DL) RRC message to the distributed unit. The system is configured to receive, at the distributed unit, a hybrid automatic repeat request (HARQ) feedback message from the UE. The system is configured to send, by the distributed unit, a DL common control channel (CCCH) message to the UE. The system is configured to receive, at the DU, an uplink control information (UCI) indication message from the UE. The system is configured to send, by the DU, the scheduling request (SR) grant with modulation and coding scheme (MCS) and resource blocks (RBs) to the UE. The system is configured to receive, at the DU, a RRC setup complete message from the UE.

In some embodiments, the system is further configured to send, by the DU, an UL RRC complete message to the CU.

In some embodiments, the system is further configured to allocate a plurality of physical uplink control channel (PUCCH) resources to the UE after receiving the RRC set up request.

In some embodiments, a size of the MCS and a number of the RBs is determined based on an uplink (UL) signal to noise ratio (SINR).

In an exemplary embodiment, the present invention discloses a network comprising a plurality of network elements for managing radio resource control (RRC) setup time with a scheduling request (SR) grant. The network is configured to send, by a distributed unit (DU), a random access response (RAR) to a user equipment (UE) after receiving a random access channel (RACH) request. The network is configured to receive, at the DU, a RRC set up request from the UE. The network is configured to send, by the DU, an initial uplink (UL) RRC message to a centralized unit (CU). The network is configured to send, by the DU, a medium access control (MAC) control element (CE) to the UE. The network is configured to send, by the CU, a downlink (DL) RRC message to the DU. The network is configured to receive, at the DU, a hybrid automatic repeat request (HARQ) feedback message from the UE. The network is configured to send, by the DU, a DL common control channel (CCCH) message to the UE. The network is configured to receive, at the DU, an uplink control information (UCI) indication message from the UE. The network is configured to send, by the DU, the scheduling request (SR) grant with modulation and coding scheme (MCS) and resource blocks (RBs) to the UE. The network is configured to receive, at the DU, a RRC setup complete message from the UE.

In some embodiments, the network is further configured to send, by the DU an UL RRC complete message to the CU.

In some embodiments, the network is further configured to allocate a plurality of physical uplink control channel (PUCCH) resources to the UE after receiving the RRC set up request.

In some embodiments, a size of the MCS and a number of the RBs is determined based on an uplink (UL) signal to noise ratio (SINR).

In an exemplary embodiment, the present invention discloses method for a scheduling request (SR) proactive grant. The method comprising sending, by a distributed unit (DU), a random access response (RAR) to a user equipment (UE) after receiving a random access channel (RACH) request. The method comprising receiving, at the DU, a RRC set up request from the UE. The method comprising sending, by the DU, an initial uplink (UL) RRC message to a centralized unit (CU). The method comprising sending, by the DU, a medium access control (MAC) control element (CE) to the UE. The method comprising sending, by the CU, a downlink (DL) RRC message to the DU. The method comprising receiving, at the DU, a hybrid automatic repeat request (HARQ) feedback message from the UE. The method comprising sending, by the DU, a DL common control channel (CCCH) message to the UE. The method comprising allocating, by the DU, a plurality of resources for transmission of at least one message from the UE. The method comprising sending, by the DU, the SR proactive grant to the UE. The method comprising receiving, at the DU, a RRC setup complete message from the UE.

In some embodiments, the SR proactive grant is based on an average size of the at least one message and an uplink (UL) signal to noise ratio (SINR).

In an exemplary embodiment, the present invention discloses a user equipment (UE) attached to a network comprising a plurality of network elements for managing radio resource control (RRC) setup time with a scheduling request

(SR) grant. The UE is configured to receive, from a distributed unit (DU), a random access response (RAR) after sending a random access channel (RACH) request to the DU. The UE is configured to send, to the DU, a RRC set up request; receive, from the DU, a medium access control (MAC) control element (CE). The DU is configured to send an initial uplink (UL) RRC message to a centralized unit (CU) and the CU is configured to send a downlink (DL) RRC message to the DU. The UE is configured to send, to the DU, a hybrid automatic repeat request (HARQ) feedback message. The UE is configured to receive, from the DU, a DL common control channel (CCCH) message. The UE is configured to send, to the DU, an uplink control information (UCI) indication message. The UE is configured to receive, from the DU, the scheduling request (SR) grant with modulation and coding scheme (MCS) and resource blocks (RBs). The UE is configured to send, to the DU, a RRC setup complete message.

In an exemplary embodiment, the present invention discloses a user equipment (UE) attached to a network comprising a plurality of network elements for a scheduling request (SR) proactive grant. The UE is configured to receive, from a distributed unit (DU), a random access response (RAR) after sending a random access channel (RACH) request to the DU. The UE is configured to send, to the DU, a RRC set up request. The UE is configured to receive, from the DU, a medium access control (MAC) control element (CE). The DU is configured to send an initial uplink (UL) RRC message to a centralized unit (CU) and the CU is configured to send a downlink (DL) RRC message to the DU. The UE is configured to send, to the DU, a hybrid automatic repeat request (HARQ) feedback message. The UE is configured to receive, from the DU, a DL common control channel (CCCH) message. The UE is configured to allocate, by the DU, a plurality of resources for transmission of at least one message from the UE. The UE is configured to receive, from the DU, the SR proactive grant and send, to the DU, a RRC setup complete message.

### BRIEF DESCRIPTION OF DRAWINGS

The accompanying drawings, which are incorporated herein, and constitute a part of this disclosure, illustrate exemplary embodiments of the disclosed methods and systems which like reference numerals refer to the same parts throughout the different drawings. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes the disclosure of electrical components, electronic components, or circuitry commonly used to implement such components.

FIG. 1 illustrates an exemplary network architecture for implementing a proposed system (108), in accordance with an embodiment of the present disclosure.

FIG. 2 illustrates an exemplary block diagram (200) of a proposed system (108), in accordance with an embodiment of the present disclosure.

FIG. 3 illustrates an exemplary flow diagram (300) for radio resource control (RRC) connection setup procedure, in accordance with an embodiment of the present disclosure.

FIG. 4 illustrates an exemplary architecture diagram (400) implemented with a centralized unit (CU) and a distributed unit (DU), in accordance with an embodiment of the present disclosure.

FIG. 5 illustrates an exemplary sequence diagram (500) for a scheduling request (SR) proactive grant by a base station upon RRC setup completion, in accordance with an embodiment of the present disclosure.

FIG. 6 illustrates an exemplary computer system (600) in which or with which the embodiments of the present disclosure may be implemented.

FIG. 7 illustrates an exemplary flow diagram for a method for managing radio resource control (RRC) setup time with a scheduling request (SR) grant, in accordance with an embodiment of the present disclosure.

FIG. 8 illustrates an exemplary flow diagram for a method for a scheduling request (SR) proactive grant, in accordance with an embodiment of the present disclosure.

The foregoing shall be more apparent from the following more detailed description of the disclosure.

### LIST OF REFERENCE NUMERALS

100—Network architecture
102-1, 102-2 . . . 102-N—A plurality of users
104-1, 104-2 . . . 104-N—A plurality of computing devices
106—Network
108—System
200—Block Diagram
202—A plurality of processor(s)
204—Memory
206—A plurality of interface(s)
208—Processing engine
210—Data Parameter Engine
212—Database
300—Flow Diagram
302—User Equipment
304—Distributed Unit (DU)
306—Centralized Unit (CU)
400—Architecture Diagram
500—Sequence Diagram
600—A computer system
610—External storage device
620—Bus
630—Main memory
640—Read only memory
650—Mass storage device
660—Communication port(s)
670—Processor
700—Flow diagram
800—Flow diagram

### DETAILED DESCRIPTION

In the following description, for explanation, various specific details are outlined in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail to avoid obscuring the embodiments.

Also, it is noted that individual embodiments may be described as a process that is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive like the term “comprising” as an open transition word without precluding any additional or other elements.

Reference throughout this specification to “one embodiment” or “an embodiment” or “an instance” or “one instance” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is to describe particular embodiments only and is not intended to be limiting the disclosure. As used herein, the singular forms “a”, “an”, and “the” are intended to include the plural forms as well, unless the context indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any combinations of one or more of the associated listed items.

### Definitions

The term RACH as used herein, refers to random access channel. In 5G communication system, when UEs are attempting to access a base station (gNB) (whether initial access, uplink data during connection, or handover), they generate and send random access channel (RACH) preambles according to a random access procedure.

The term RRC as used herein, refers to radio resource control. In the 5G communication system, before communication is performed between the gNB and the UE, the gNB and the UE need to complete connection establishment, i.e. RRC connection establishment, first. The RRC performs radio resource management, control and scheduling through a certain strategy and means, and makes full use of limited radio network resources as much as possible under the condition of meeting the requirement of service quality.

The term RAR as used herein, refers to random access response. The UE initiates a random access procedure and sends a preamble to the gNB. After detecting the preamble, the gNB sends a random access response (RAR) to the UE.

The term HARQ as used herein, refers to hybrid automatic repeat request. Hybrid automatic repeat request (hybrid ARQ or HARQ) is a combination of high-rate forward error correction (FEC) and automatic repeat request (ARQ) error-control.

The term CCCH as used herein, refers to common control channel. CCCH is used on both the downlink and uplink for transmitting control information to and from the UEs.

The term MCS as used herein, refers to modulation and coding scheme. MCS is a crucial parameter that determines how data is modulated and encoded for transmission over the air interface between the gNB and the UE.

The term PUCCH as used herein, refers to physical uplink control channel. PUCCH channel is used to transport uplink control information (UCI) from the UE to the gNB.

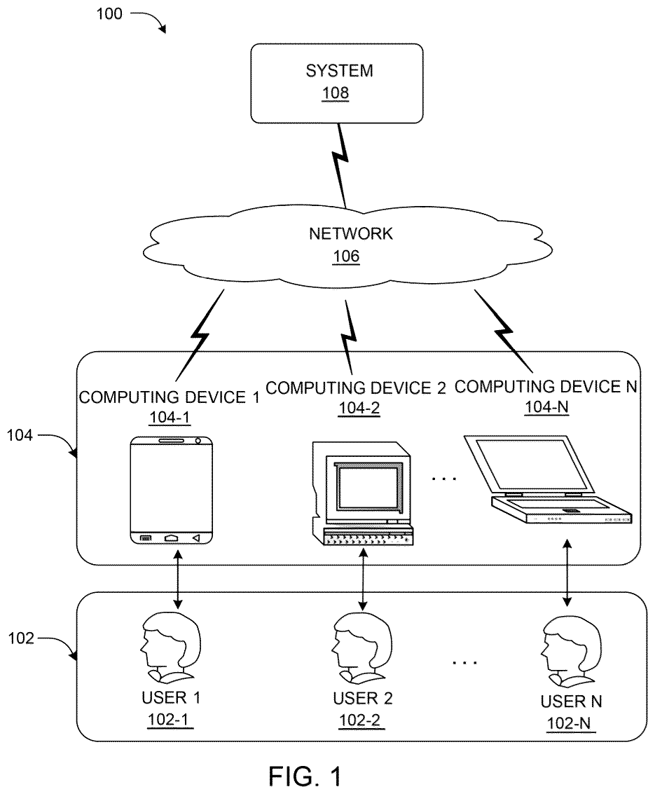

The various embodiments throughout the disclosure will be explained in more detail with reference to FIGS. 1-6.

FIG. 1 illustrates an exemplary network architecture (100) for implementing a proposed system (108), in accordance with an embodiment of the present disclosure.

As illustrated in FIG. 1, one or more computing devices (104-1, 104-2 . . . 104-N) may be connected to a proposed system (108) through a network (106). A person of ordinary skill in the art will understand that the one or more computing devices (104-1, 104-2 . . . 104-N) may be collectively referred as computing devices (104) and individually referred as a computing device (104). One or more users (102-1, 102-2 . . . 102-N) may provide one or more requests to the system (108). In an embodiment, the one or more requests may be based on a physical uplink shared channel (PUSCH) transmission request sent by the computing device (104). A person of ordinary skill in the art will understand that the one or more users (102-1, 102-2 . . . 102-N) may be collectively referred as users (102) and individually referred as a user (102). Further, the computing devices (104) may also be referred as a user equipment (UE) (104) or as UEs (104) throughout the disclosure.

In an embodiment, the computing device (104) may include, but not be limited to, a mobile, a laptop, etc. Further, the computing device (104) may include one or more in-built or externally coupled accessories including, but not limited to, a visual aid device such as a camera, audio aid, microphone, or keyboard. Furthermore, the computing device (104) may include a mobile phone, smartphone, virtual reality (VR) devices, augmented reality (AR) devices, a laptop, a general-purpose computer, a desktop, a personal digital assistant, a tablet computer, and a mainframe computer. Additionally, input devices for receiving input from the user (102) such as a touchpad, touch-enabled screen, electronic pen, and the like may be used.

In an embodiment, the system (108) may receive the one or more requests from the users (102) via the computing devices (104). The system (108) may allocate a physical uplink control channel (PUCCH) resource corresponding to a scheduling request (SR) and a channel state information (CSI) to the computing device (104).

In an embodiment, the system (108) may receive an acknowledgement from the computing device (104), and the system (108) may forward a radio resource control (RRC) setup message using a downlink (DL) common control channel (CCCH) message to the computing device (104).

In an embodiment, the system (108) may allocate the required resources based on a transmission of a message received from the computing device (104). The system (108) may receive an uplink (UL) channel quality from the computing device (104),

In an embodiment, the system (108) may schedule the UL grant based on a signal to noise ratio (SINR) received from a previous UL message. Hence, the system (108) may generate a modulation coding scheme (MCS) and resource block (RB) such that one or more radio link control (RLC) level segmentations may be avoided, and time taken for RRC setup may be reduced.

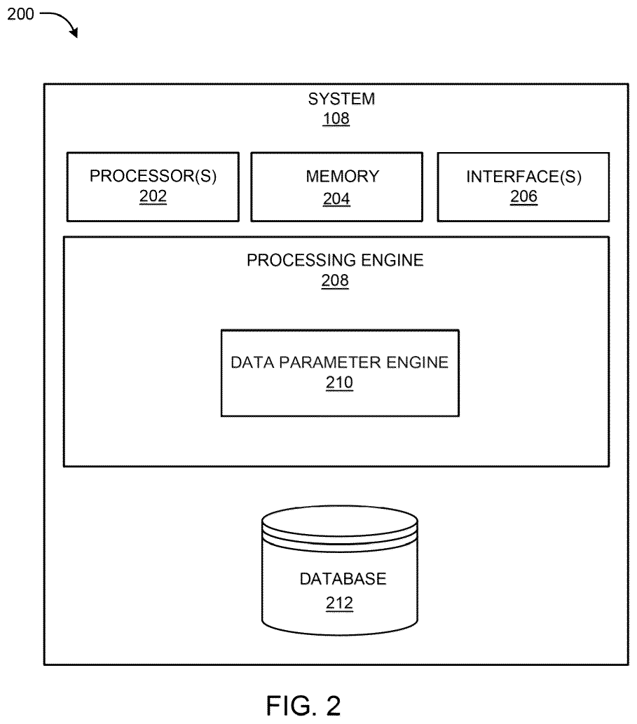

FIG. 2 illustrates an exemplary block diagram (200) of a proposed system (108), in accordance with an embodiment of the present disclosure.

Referring to FIG. 2, in an embodiment, the system (108) may include one or more processor(s) (202). The one or more processor(s) (202) may be implemented as one or more microprocessors, microcomputers, microcontrollers, digital signal processors, central processing units, logic circuitries, and/or any devices that process data based on operational instructions. Among other capabilities, the one or more processor(s) (202) may be configured to fetch and execute computer-readable instructions stored in a memory (204) of the system (108). The memory (204) may be configured to store one or more computer-readable instructions or routines in a non-transitory computer readable storage medium, which may be fetched and executed to create or share data packets over a network service. The memory (204) may comprise any non-transitory storage device including, for example, volatile memory such as random-access memory (RAM), or non-volatile memory such as erasable programmable read only memory (EPROM), flash memory, and the like.

In an embodiment, the system (108) may include an interface(s) (206). The interface(s) (206) may comprise a variety of interfaces, for example, interfaces for data input and output devices (I/O), storage devices, and the like. The interface(s) (206) may facilitate communication through the system (108). The interface(s) (206) may also provide a communication pathway for one or more components of the system (108). Examples of such components include, but are not limited to, processing engine(s) (208) and a database (212). Further, the processing engine(s) (208) may include a data parameter engine (210).

In an embodiment, the processing engine(s) (208) may be implemented as a combination of hardware and programming (for example, programmable instructions) to implement one or more functionalities of the processing engine(s) (208). In examples described herein, such combinations of hardware and programming may be implemented in several different ways. For example, the programming for the processing engine(s) (208) may be processor-executable instructions stored on a non-transitory machine-readable storage medium and the hardware for the processing engine(s) (208) may comprise a processing resource (for example, one or more processors), to execute such instructions. In the present examples, the machine-readable storage medium may store instructions that, when executed by the processing resource, implement the processing engine(s) (208). In such examples, the system may comprise the machine-readable storage medium storing the instructions and the processing resource to execute the instructions, or the machine-readable storage medium may be separate but accessible to the system and the processing resource. In other examples, the processing engine(s) (208) may be implemented by electronic circuitry.

In an embodiment, the processor (202) may receive the one or more requests from the users (102) via the data parameter engine (210). The users (102) may send the one or more requests via the computing device (104). The processor (202) may store the one or more requests in the database (212). The processor (202) may allocate a PUCCH resource corresponding to a SR and a CSI to the computing device (104).

In an embodiment, the processor (202) may receive an acknowledgement from the computing device (104), and the processor (202) may forward a RRC setup message using a DL CCCH message to the computing device (104).

In an embodiment, the processor (202) may allocate the required resources based on a transmission of a message received from the computing device (104). The processor (202) may receive an UL quality from the computing device (104),

In an embodiment, the processor (202) may schedule the UL grant based on a SINR received from a previous UL message. Hence, the processor (202) may generate a MCS and RB such that one or more RLC level segmentations may be avoided, and time taken for RRC setup may be reduced.

Although FIG. 2 shows exemplary components of the system (108), in other embodiments, the system (108) may include fewer components, different components, differently arranged components, or additional functional components than depicted in FIG. 2. Additionally, or alternatively, one or more components of the system (108) may perform functions described as being performed by one or more other components of the system (108).

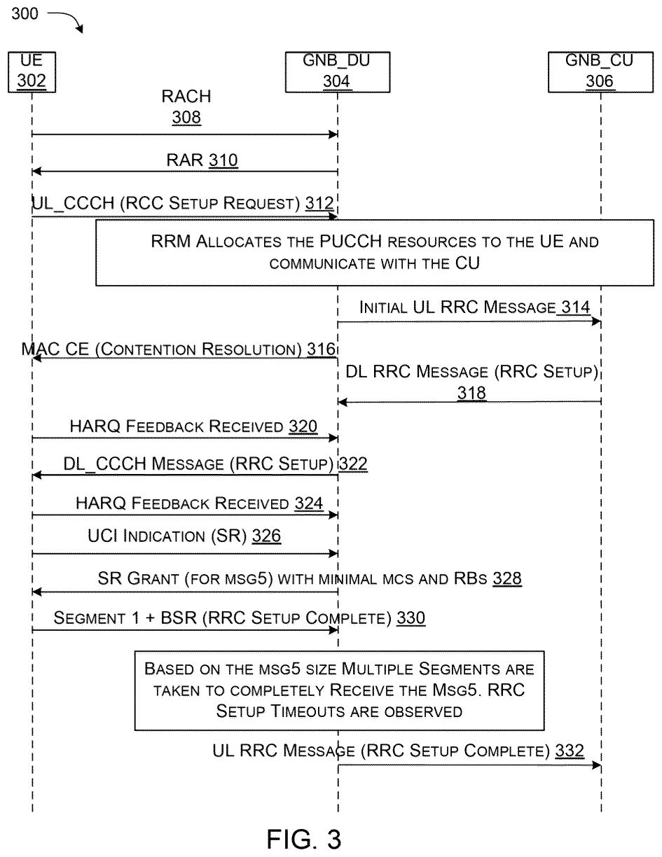

FIG. 3 illustrates an exemplary flow diagram (300) for radio resource control (RRC) connection setup procedure, in accordance with an embodiment of the present disclosure.

As illustrated in FIG. 3, the following steps may be implemented.

At step 308: The UE (302) may send a random access channel (RACH) request to a distributed unit (304). It may be appreciated that the UE (302) may be similar to the UE (104) of FIG. 1.

At step 310: The distributed unit (304) may send a random access response (RAR) to the UE (302).

At step 312: The UE (302) may send the RRC setup request to the distributed unit (304). The radio resource management (RRM) may allocate the PUCCH resources to the UE (302) and communicate with a base station centralized unit (306).

At step 314: The distributed unit (304) may send an initial UL RRC message to the centralized unit (306).

At step 316: The distributed unit (304) may send a medium access control (MAC) control element (CE) to the UE (302).

At step 318: The centralized unit (306) may send a DL RRC message to the distributed unit (304).

At step 320: The UE (302) may send a hybrid automatic repeat request (HARQ) feedback received message to the distributed unit (304).

At step 322: The distributed unit (304) may send a DL CCCH message to the UE (302).

At step 324: The UE (302) may send a HARQ feedback received message to the distributed unit (304).

At step 326: The UE (302) may send an uplink control information (UCI) indication message to the distributed unit (304).

At step 328: The distributed unit (304) may send a SR grant with

MCS and RBs to the UE (302).

At step 330: The UE (302) may send a RRC setup complete message to the distributed unit (304). Based on the RRC setup complete message, multiple segments may be prepared by the distributed unit (304) and the centralized unit (306) to receive the RRC setup complete message. Further, RRC timeouts may be observed.

At step 332: The distributed unit (304) may send a UL RRC message to the centralized unit (306).

In an embodiment, the system/base station (108 or 304) may include multiple layers, but not limited to, an evolved general packet radio service (GPRS) tunnelling protocol user (E-GTPU) layer, a new radio (NR)-UP layer, an RLC layer, a MAC layer, and a physical layer (PHY) where DL data may be either signalling data or user data received from the centralized unit (306). The E-GTPU layer may take care of forwarding the user data to RLC and a FIAP protocol may handle the signalling messages and forward the signalling messages to the RLC layer.

In an embodiment, the RLC layer may be responsible for sending the buffer occupancy (BO) information to MAC layer to get the grant for each logical channel to transmit the RLC service data unit (SDU) received from the upper layers. The MAC layer may provide the grant to RLC based on the calculated transport block (TB) size based on the channel conditions and perform multiplexing of different logical channel data received from the RLC for the same UE (302). The MAC layer may prepare a TB and place it in slot buffers to schedule such that the

PHY layer may schedule over the air. Similarly, in UL direction, the MAC layer may use a de-multiplexer to forward data to the RLC corresponding to each logical channel. Further, the RLC may forward the data to upper layers in a similar manner. In an embodiment, just after receiving the HARQ ACK for the MAC

packet data unit (PDU), the distributed unit (304) may allocate the required resources for transmission from the UE (302) (based upon the determination of good UL RF conditions) and send the grant proactively without waiting for SR from the UE (302). The distributed unit (304) may proactively allocate resources and target higher MCS and RB (based on the channel quality analysed earlier) so that

RLC level segmentations may be avoided. Because of this advancement, the time taken for RRC idle to connect may be reduced. In the present case, a new SR may be simulated and without using the actual SR received from the UE (302) and hence the RBs may be allocated based on real time conditions of the channel.

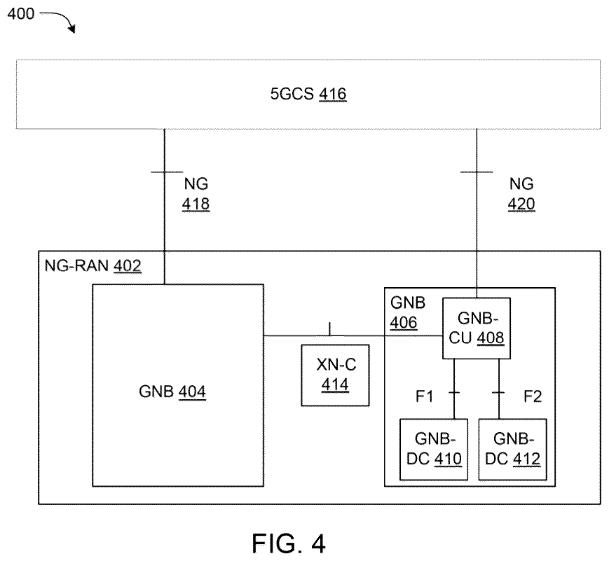

FIG. 4 illustrates an exemplary architecture diagram (400) implemented with a centralized unit (CU) and a distributed unit (DU), in accordance with an embodiment of the present disclosure.

As illustrated in FIG. 4, the NG-RAN (402) may include a base station (404) and a base station (406). The base station (406) may include a centralized unit (408) and one or more distributed units (410, 412). The base stations (404, 406) may be connected using an Xn-C interface (414). The NG-RAN (402) may be connected to a fifth generation core system (5GCS) (416) using one or more NG interfaces (418, 420).

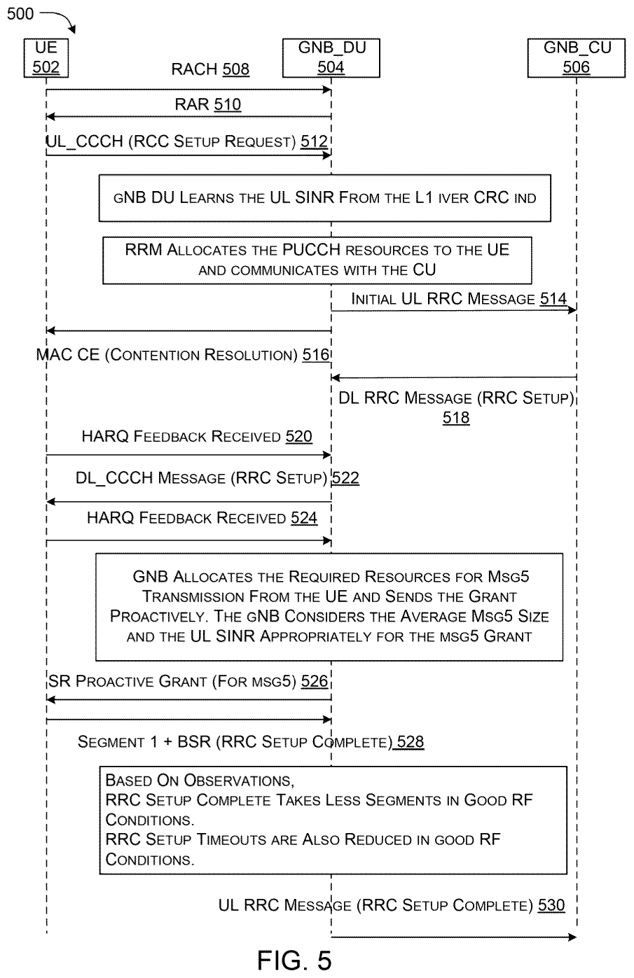

FIG. 5 illustrates an exemplary sequence diagram (500) for a scheduling request (SR) proactive grant by a base station upon RRC setup completion, in accordance with an embodiment of the present disclosure.

As illustrated in FIG. 5, the following steps may be implemented.

At step 508: A UE (502) may send a RACH request to a distributed unit (304).

At step 510: The distributed unit (504) may send a RAR to the UE (502).

At step 512: The UE (502) may send the UL CCCH to the distributed unit (504). The distributed unit (504) may learn the UL SINR from the L1 IVER cyclic redundancy check (CRC) IND. The RRM may allocate the PUCCH resources to the UE (502) and communicate through a centralized unit (506).

At step 514: The distributed unit (504) may send an initial UL RRC message to the centralized unit (506).

At step 516: The distributed unit (504) may send a MAC CE to the UE (502).

At step 518: The centralized unit (506) may send a DL RRC message to the distributed unit (504).

At step 520: The UE (502) may send a HARQ feedback received message to the distributed unit (504).

At step 522: The distributed unit (504) may send a DL CCCH message to the UE (502).

At step 524: The UE (502) may send a HARQ feedback received message to the distributed unit (504). The distributed unit (504) may allocate the required resources for the message transmission from the UE (502). Further, the distributed unit (504) may send the grant proactively. Based on the average size of the msg5 and UL SINR of the previous UL message, the distributed unit (504) may determine the grant size.

At step 526: The distributed unit (504) may send a proactive SR grant to the UE (502).

At step 528: The UE (502) may send a RRC setup complete message to the distributed unit (504). Based on the RRC setup complete message, RRC setup may be completed with less time with good RF conditions. Further, the RRC setup timeouts may also be reduced in good RF conditions.

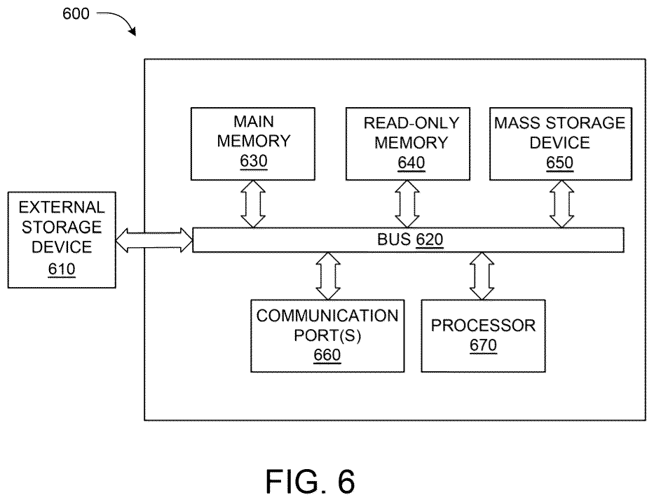

At step 530: The distributed unit (504) may send a UL RRC message to the centralized unit (506). FIG. 6 illustrates an exemplary computer system (600) in which or

with which embodiments of the present disclosure may be implemented.

As shown in FIG. 6, the computer system (600) may include an external storage device (610), a bus (620), a main memory (630), a read-only memory (640), a mass storage device (650), a communication port(s) (660), and a processor (670). A person skilled in the art will appreciate that the computer system (600) may include more than one processor and communication ports. The processor (670) may include various modules associated with embodiments of the present disclosure. The communication port(s) (660) may be any of an RS-232 port for use with a modem-based dialup connection, a 10/100 Ethernet port, a Gigabit or 10 Gigabit port using copper or fiber, a serial port, a parallel port, or other existing or future ports. The communication ports(s) (660) may be chosen depending on a network, such as a Local Area Network (LAN), Wide Area Network (WAN), or any network to which the computer system (600) connects.

In an embodiment, the main memory (630) may be Random Access Memory (RAM), or any other dynamic storage device commonly known in the art. The read-only memory (640) may be any static storage device(s) e.g., but not limited to, a Programmable Read Only Memory (PROM) chip for storing static information e.g., start-up or basic input/output system (BIOS) instructions for the processor (670). The mass storage device (650) may be any current or future mass storage solution, which can be used to store information and/or instructions.

Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces).

In an embodiment, the bus (620) may communicatively couple the processor(s) (670) with the other memory, storage, and communication blocks. The bus (620) may be, e.g., a Peripheral Component Interconnect PCI)/PCI Extended (PCI-X) bus, Small Computer System Interface (SCSI), USB, or the like, for connecting expansion cards, drives, and other subsystems as well as other buses, such a front side bus (FSB), which connects the processor (670) to the computer system (600).

In another embodiment, operator and administrative interfaces, e.g., a display, keyboard, and cursor control device may also be coupled to the bus (620) to support direct operator interaction with the computer system (600). Other operator and administrative interfaces can be provided through network connections connected through the communication port(s) (660). Components described above are meant only to exemplify various possibilities. In no way should the aforementioned exemplary computer system (600) limit the scope of the present disclosure.

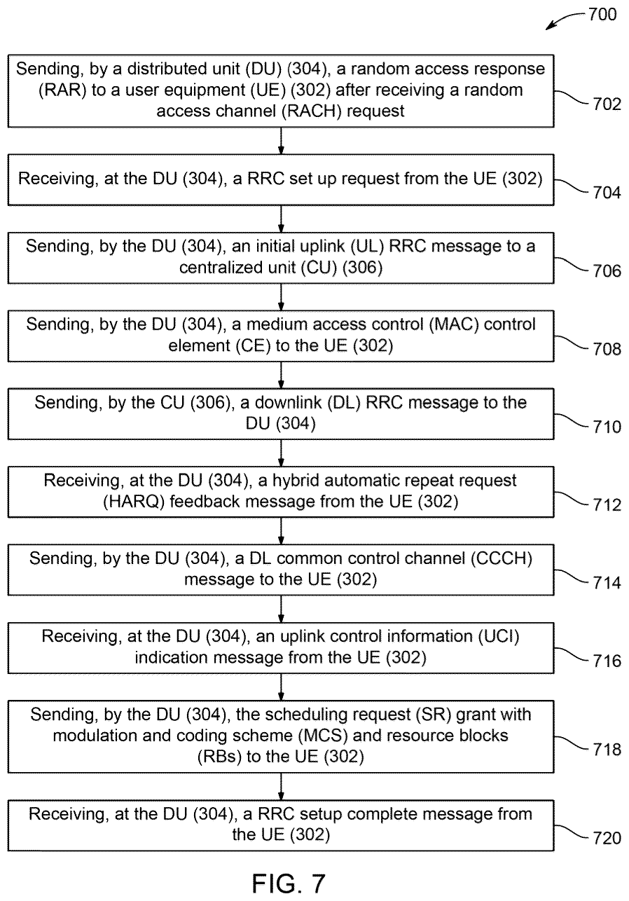

FIG. 7 illustrates an exemplary flow diagram for a method (700) for managing radio resource control (RRC) setup time with a scheduling request (SR) grant, in accordance with an embodiment of the present disclosure.

At step 702, the method comprising sending, by a distributed unit (DU) (304), a random access response (RAR) to a user equipment (UE) (302) after receiving a random access channel (RACH) request.

At step 704, the method comprising receiving, at the DU (304), a RRC set up request from the UE (302).

At step 706, the method comprising sending, by the DU (304), an initial uplink (UL) RRC message to a centralized unit (CU) (306).

At step 708, the method comprising sending, by the DU (304), a medium access control (MAC) control element (CE) to the UE (302).

At step 710, the method comprising sending, by the CU (306), a downlink (DL) RRC message to the DU (304).

At step 712, the method comprising receiving, at the DU (304), a hybrid automatic repeat request (HARQ) feedback message from the UE (302).

At step 714, the method comprising sending, by the DU (304), a DL common control channel (CCCH) message to the UE (302).

At step 716, the method comprising receiving, at the DU (304), an uplink control information (UCI) indication message from the UE (302).

At step 718, the method comprising sending, by the DU (304), the scheduling request (SR) grant with modulation and coding scheme (MCS) and resource blocks (RBs) to the UE (302).

At step 720, the method comprising receiving, at the DU (304), a RRC setup complete message from the UE (302).

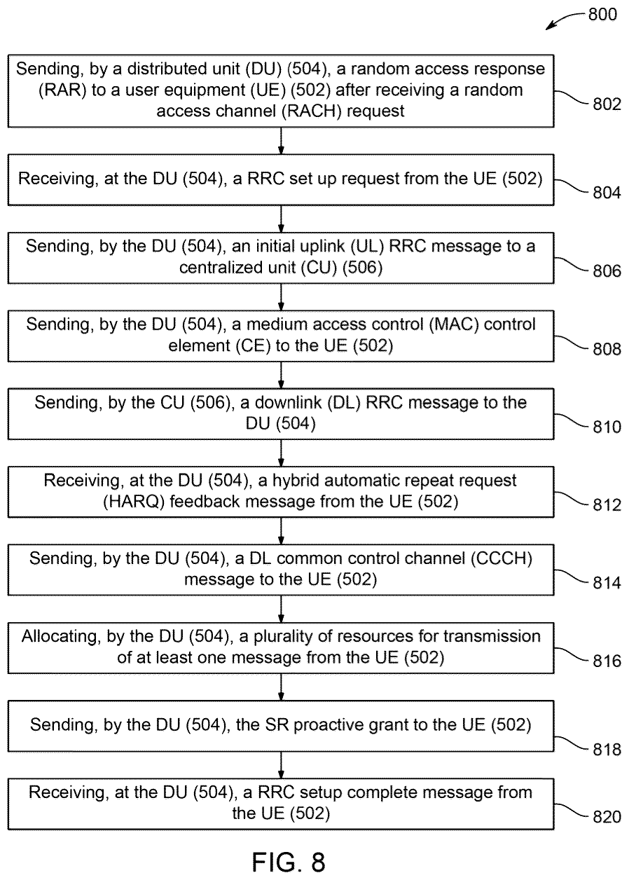

FIG. 8 illustrates an exemplary flow diagram for a method (800) for a scheduling request (SR) proactive grant, in accordance with an embodiment of the present disclosure.

At step 802, the method comprising sending, by a distributed unit (DU) (504), a random access response (RAR) to a user equipment (UE) (502) after receiving a random access channel (RACH) request.

At step 804, the method comprising receiving, at the DU (504), a RRC set up request from the UE (502).

At step 806, the method comprising sending, by the DU (504), an initial uplink (UL) RRC message to a centralized unit (CU) (506).

At step 808, the method comprising sending, by the DU (504), a medium access control (MAC) control element (CE) to the UE (502).

At step 810, the method comprising sending, by the CU (506), a downlink (DL) RRC message to the DU (504).

At step 812, the method comprising receiving, at the DU (504), a hybrid automatic repeat request (HARQ) feedback message from the UE (502).

At step 814, the method comprising sending, by the DU (504), a DL common control channel (CCCH) message to the UE (502).

At step 816, the method comprising allocating, by the DU (504), a plurality of resources for transmission of at least one message from the UE (502).

At step 818, the method comprising sending, by the DU (504), the SR proactive grant to the UE (502).

At step 820, the method comprising receiving, at the DU (504), a RRC setup complete message from the UE (502).

While considerable emphasis has been placed herein on the preferred embodiments, it will be appreciated that many embodiments can be made and that many changes can be made in the preferred embodiments without departing from the principles of the disclosure. These and other changes in the preferred embodiments of the disclosure will be apparent to those skilled in the art from the disclosure herein, whereby it is to be distinctly understood that the foregoing descriptive matter is to be implemented merely as illustrative of the disclosure and not as a limitation.

In an exemplary embodiment, the present invention discloses a method for managing radio resource control (RRC) setup time with a scheduling request (SR) grant. The method comprising sending, by a distributed unit (DU), a random access response (RAR) to a user equipment (UE) after receiving a random access channel (RACH) request. The method comprising receiving, at the DU, a RRC set up request from the UE. The method comprising sending, by the DU, an initial uplink (UL) RRC message to a centralized unit (CU). The method comprising sending, by the DU, a medium access control (MAC) control element (CE) to the UE. The method comprising sending, by the CU, a downlink (DL) RRC message to the DU. The method comprising receiving, at the DU, a hybrid automatic repeat request (HARQ) feedback message from the UE. The method comprising sending, by the DU, a DL common control channel (CCCH) message to the UE. The method comprising receiving, at the DU, an uplink control information (UCI) indication message from the UE. The method comprising sending, by the DU, the scheduling request (SR) grant with modulation and coding scheme (MCS) and resource blocks (RBs) to the UE. The method comprising receiving, at the DU, a RRC setup complete message from the UE.

In some embodiments, the method further comprising sending, by the distributed unit an UL RRC complete message to the CU. In some embodiments, the method further comprising allocating a plurality of physical uplink control channel (PUCCH) resources to the UE after receiving the RRC set up request. In some embodiments, a size of the MCS and a number of the RBs is determined based on an uplink (UL) signal to noise ratio (SINR).

In an exemplary embodiment, the present invention discloses a system for managing radio resource control (RRC) setup time with a scheduling request (SR) grant. The system is configured to send, by a distributed unit (DU), a random access response (RAR) to a user equipment (UE) after receiving a random access channel (RACH) request. The system is configured to receive, at the distributed unit, a RRC set up request from the UE. The system is configured to send, by the distributed unit, an initial uplink (UL) RRC message to a centralized unit (CU). The system is configured to send, by the distributed unit, a medium access control (MAC) control element (CE) to the UE. The system is configured to send, by the CU, a downlink (DL) RRC message to the distributed unit. The system is configured to receive, at the distributed unit, a hybrid automatic repeat request (HARQ) feedback message from the UE. The system is configured to send, by the distributed unit, a DL common control channel (CCCH) message to the UE. The system is configured to receive, at the DU, an uplink control information (UCI) indication message from the UE. The system is configured to send, by the DU, the scheduling request (SR) grant with modulation and coding scheme (MCS) and resource blocks (RBs) to the UE. The system is configured to receive, at the DU, a RRC setup complete message from the UE.

In some embodiments, the system is further configured to send, by the DU, an UL RRC complete message to the CU. In some embodiments, the system is further configured to allocate a plurality of physical uplink control channel (PUCCH) resources to the UE after receiving the RRC set up request. In some embodiments, a size of the MCS and a number of the RBs is determined based on an uplink (UL) signal to noise ratio (SINR).

In an exemplary embodiment, the present invention discloses a network comprising a plurality of network elements for managing radio resource control (RRC) setup time with a scheduling request (SR) grant. The network is configured to send, by a distributed unit (DU), a random access response (RAR) to a user equipment (UE) after receiving a random access channel (RACH) request.

The network is configured to receive, at the DU, a RRC set up request from the UE. The network is configured to send, by the DU, an initial uplink (UL) RRC message to a centralized unit (CU). The network is configured to send, by the DU, a medium access control (MAC) control element (CE) to the UE. The network is configured to send, by the CU, a downlink (DL) RRC message to the DU. The network is configured to receive, at the DU, a hybrid automatic repeat request (HARQ) feedback message from the UE. The network is configured to send, by the DU, a DL common control channel (CCCH) message to the UE. The network is configured to receive, at the DU, an uplink control information (UCI) indication message from the UE. The network is configured to send, by the DU, the scheduling request (SR) grant with modulation and coding scheme (MCS) and resource blocks (RBs) to the UE. The network is configured to receive, at the DU, a RRC setup complete message from the UE.

In some embodiments, the network is further configured to send, by the DU an UL RRC complete message to the CU. In some embodiments, the network is further configured to allocate a plurality of physical uplink control channel (PUCCH) resources to the UE after receiving the RRC set up request. In some embodiments, a size of the MCS and a number of the RBs is determined based on an uplink (UL) signal to noise ratio (SINR).

In an exemplary embodiment, the present invention discloses method for a scheduling request (SR) proactive grant. The method comprising sending, by a distributed unit (DU), a random access response (RAR) to a user equipment (UE) after receiving a random access channel (RACH) request. The method comprising receiving, at the DU, a RRC set up request from the UE. The method comprising sending, by the DU, an initial uplink (UL) RRC message to a centralized unit (CU). The method comprising sending, by the DU, a medium access control (MAC) control element (CE) to the UE. The method comprising sending, by the CU, a downlink (DL) RRC message to the DU. The method comprising receiving, at the DU, a hybrid automatic repeat request (HARQ) feedback message from the UE. The method comprising sending, by the DU, a DL common control channel (CCCH) message to the UE. The method comprising allocating, by the DU, a plurality of resources for transmission of at least one message from the UE. The method comprising sending, by the DU, the SR proactive grant to the UE. The method comprising receiving, at the DU, a RRC setup complete message from the UE.

In some embodiments, the SR proactive grant is based on an average size of the at least one message and an uplink (UL) signal to noise ratio (SINR).

In an exemplary embodiment, the present invention discloses a user equipment (UE) attached to a network comprising a plurality of network elements for managing radio resource control (RRC) setup time with a scheduling request (SR) grant. The UE is configured to receive, from a distributed unit (DU), a random access response (RAR) after sending a random access channel (RACH) request to the DU. The UE is configured to send, to the DU, a RRC set up request; receive, from the DU, a medium access control (MAC) control element (CE). The DU is configured to send an initial uplink (UL) RRC message to a centralized unit (CU) and the CU is configured to send a downlink (DL) RRC message to the DU. The

UE is configured to send, to the DU, a hybrid automatic repeat request (HARQ) feedback message. The UE is configured to receive, from the DU, a DL common control channel (CCCH) message. The UE is configured to send, to the DU, an uplink control information (UCI) indication message. The UE is configured to receive, from the DU, the scheduling request (SR) grant with modulation and coding scheme (MCS) and resource blocks (RBs). The UE is configured to send, to the DU, a RRC setup complete message.

In an exemplary embodiment, the present invention discloses a user equipment (UE) attached to a network comprising a plurality of network elements for a scheduling request (SR) proactive grant. The UE is configured to receive, from a distributed unit (DU), a random access response (RAR) after sending a random access channel (RACH) request to the DU. The UE is configured to send, to the DU, a RRC set up request. The UE is configured to receive, from the DU, a medium access control (MAC) control element (CE). The DU is configured to send an initial uplink (UL) RRC message to a centralized unit (CU) and the CU is configured to send a downlink (DL) RRC message to the DU. The UE is configured to send, to the DU, a hybrid automatic repeat request (HARQ) feedback message. The UE is configured to receive, from the DU, a DL common control channel (CCCH) message. The UE is configured to allocate, by the DU, a plurality of resources for transmission of at least one message from the UE. The UE is configured to receive, from the DU, the SR proactive grant and send, to the DU, a RRC setup complete message.

In an aspect, the present disclosure provides a system and a method that improves initial uplink (UL) message transmission timing by scheduling a proactive grant through channel aware scheduling which in turn reduces the radio resource control (RRC) connection setup time. Further, upon receiving an acknowledgement for a downlink common control channel (DL-CCCH) message, a grant is provided to the UE that reduces the RRC connection setup time. Further, the present disclosure provides an improvement in RRC connection setup key performance indicator (KPI) and reduces the RRC connection failures due to latencies on an air interface associated with the scheduling request (SR).

In an aspect, the present disclosure can be implemented within a 5G communication network or with various network elements that may involve various algorithms, protocols, or mechanisms.

### Advantages of the Invention

The present disclosure provides a system and a method that improves initial uplink (UL) message transmission timing by scheduling a proactive grant through channel aware scheduling which in turn reduces the radio resource control (RRC) connection setup time.

The present disclosure provides a system and a method that upon receiving an acknowledgement for a downlink common control channel (DL-CCCH) message, provides a grant to transmit the message that reduces the RRC connection setup time.

The present disclosure provides a system and a method that schedules uplink modulation and coding scheme (MCS) and resource block's (RB's) based on the learned UL channel signal interference and noise ratio (SINR) characteristics.

The present disclosure provides a RRC connection setup key performance indicator (KPI) and reduces the RRC connection failures due to latencies on an air interface associated with the scheduling request (SR).

The present disclosure provides an advancement to the communication system by reducing a call setup time.

We claim:

1. A method for managing radio resource control (RRC) setup time with a scheduling request (SR) grant, the method comprising:
sending, by a distributed unit (DU) (304), a random access response (RAR) to a user equipment (UE) (302) after receiving a random access channel (RACH) request;
receiving, at the DU (304), a RRC set up request from the UE (302);
sending, by the DU (304), an initial uplink (UL) RRC message to a centralized unit (CU) (306);
sending, by the DU (304), a medium access control (MAC) control element (CE) to the UE (302);
sending, by the CU (306), a downlink (DL) RRC message to the DU (304);
receiving, at the DU (304), a hybrid automatic repeat request (HARQ) feedback message from the UE (302);
sending, by the DU (304), a DL common control channel (CCCH) message to the UE (302);
receiving, at the DU (304), an uplink control information (UCI) indication message from the UE (302);
sending, by the DU (304), the scheduling request (SR) grant with modulation and coding scheme (MCS) and resource blocks (RBs) to the UE (302); and
receiving, at the DU (304), a RRC setup complete message from the UE (302).

2. The method as claimed in claim 1, further comprising sending, by the distributed unit an UL RRC complete message to the CU (306).

3. The method as claimed in claim 1, further comprising allocating a plurality of physical uplink control channel (PUCCH) resources to the UE (302) after receiving the RRC set up request.

2. The method as claimed in claim 1, wherein sending the SR grant includes the DU (304) sending the SR grant without a SR message from the UE, and wherein the SR sending the SR grant includes determining a size of the MCS and a number of the RBs is determined based on an uplink (UL) signal to noise ratio (SINR).

5. A system for managing radio resource control (RRC) setup time with a scheduling request (SR) grant, the system is configured to:
a distributed unit (DU) (304) configured to:
send a random access response (RAR) to a user equipment (UE) (302) after receiving a random access channel (RACH) request;
receive a RRC set up request from the UE (302);
send an initial uplink (UL) RRC message to a centralized unit (CU) (306);
send a medium access control (MAC) control element (CE) to the UE (302);
the CU (306) configured to send a downlink (DL) RRC message to the distributed unit;
the DU (304) is further configured to:
receive a hybrid automatic repeat request (HARQ) feedback message from the UE (302);
send a DL common control channel (CCCH) message to the UE (302);
receive an uplink control information (UCI) indication message from the UE (302);
send the scheduling request (SR) grant with modulation and coding scheme (MCS) and resource blocks (RBs) to the UE (302); and
receive a RRC setup complete message from the UE (302).

6. The system as claimed in claim 5, further configured to send, by the DU (304) an UL RRC complete message to the CU (306).

7. The system as claimed in claim 5, further configured to allocate a plurality of physical uplink control channel (PUCCH) resources to the UE (302) after receiving the RRC set up request.

8. The system as claimed in claim 5, wherein the SR grant includes determining a size of the MCS and a number of the RBs is determined based on an uplink (UL) signal to noise ratio (SINR) and wherein the DU sends the SR grant without a SR message from the UE (302).

9. A network comprising a plurality of network elements for managing radio resource control (RRC) setup time with a scheduling request (SR) grant, the network is configured to:
send, by a distributed unit (DU) (304), a random access response (RAR) to a user equipment (UE) (302) after receiving a random access channel (RACH) request;
receive, at the DU (304), a RRC set up request from the UE (302);
send, by the DU (304), an initial uplink (UL) RRC message to a centralized unit (CU) (306);
send, by the DU (304), a medium access control (MAC) control element (CE) to the UE (302);
send, by the CU (306), a downlink (DL) RRC message to the DU (304);
receive, at the DU (304), a hybrid automatic repeat request (HARQ) feedback message from the UE (302);
send, by the DU (304), a DL common control channel (CCCH) message to the UE (302);
receive, at the DU (304), an uplink control information (UCI) indication message from the UE (302);
send, by the DU (304), the scheduling request (SR) grant with modulation and coding scheme (MCS) and resource blocks (RBs) to the UE (302); and
receive, at the DU (304), a RRC setup complete message from the UE (302).

10. The network as claimed in claim 9, further configured to send, by the DU (304) an UL RRC complete message to the CU (306).

11. The network as claimed in claim 9, further configured to allocate a plurality of physical uplink control channel (PUCCH) resources to the UE (302) after receiving the RRC set up request.

12. The network as claimed in claim 9, wherein a size of the MCS and a number of the RBs is determined based on an uplink (UL) signal to noise ratio (SINR).

13. A method for a scheduling request (SR) proactive grant, the method comprising:
sending, by a distributed unit (DU) (504), a random access response (RAR) to a user equipment (UE) (502) after receiving a random access channel (RACH) request;
receiving, at the DU (504), a RRC set up request from the UE (502);
sending, by the DU (504), an initial uplink (UL) RRC message to a centralized unit (CU) (506);
sending, by the DU (504), a medium access control (MAC) control element (CE) to the UE (502);
sending, by the CU (506), a downlink (DL) RRC message to the DU (504);
receiving, at the DU (504), a hybrid automatic repeat request (HARQ) feedback message from the UE (502);
sending, by the DU (504), a DL common control channel (CCCH) message to the UE (502);
allocating, by the DU (504), a plurality of resources for transmission of at least one message from the UE (502);
sending, by the DU (504), the SR proactive grant to the UE (502); and
receiving, at the DU (504), a RRC setup complete message from the UE (502).

14. The method as claimed in claim 13, wherein the SR proactive grant is based on an average size of the at least one message and an uplink (UL) signal to noise ratio (SINR).

15. A computer program product comprising a non-transitory computer-readable medium comprising instructions that, when executed by one or more processors, cause the one or more processors to perform a method for managing radio resource control (RRC) setup time with a scheduling request (SR) grant, the method comprising:
sending, by a distributed unit (DU) (304), a random access response (RAR) to a user equipment (UE) (302) after receiving a random access channel (RACH) request;
receiving, at the DU (304), a RRC set up request from the UE (302);
sending, by the DU (304), an initial uplink (UL) RRC message to a centralized unit (CU) (306);
sending, by the DU (304), a medium access control (MAC) control element (CE) to the UE (302);
sending, by the CU (306), a downlink (DL) RRC message to the DU (304);
receiving, at the DU (304), a hybrid automatic repeat request (HARQ) feedback message from the UE (302);
sending, by the DU (304), a DL common control channel (CCCH) message to the UE (302);
receiving, at the DU (304), an uplink control information (UCI) indication message from the UE (302);
sending, by the DU (304), the scheduling request (SR) grant with modulation and coding scheme (MCS) and resource blocks (RBs) to the UE (302); and
receiving, at the DU (304), a RRC setup complete message from the UE (302).

16. A computer program product comprising a non-transitory computer-readable medium comprising instructions that, when executed by one or more processors, cause the one or more processors to perform a method for a scheduling request (SR) proactive grant, the method comprising:
sending, by a distributed unit (DU) (504), a random access response (RAR) to a user equipment (UE) (502) after receiving a random access channel (RACH) request;
receiving, at the DU (504), a RRC set up request from the UE (502);
sending, by the DU (504), an initial uplink (UL) RRC message to a centralized unit (CU) (506);
sending, by the DU (504), a medium access control (MAC) control element (CE) to the UE (502);
sending, by the CU (506), a downlink (DL) RRC message to the DU (504);
receiving, at the DU (504), a hybrid automatic repeat request (HARQ) feedback message from the UE (502);
sending, by the DU (504), a DL common control channel (CCCH) message to the UE (502);
allocating, by the DU (504), a plurality of resources for transmission of at least one message from the UE (502);
sending, by the DU (504), the SR proactive grant to the UE (502); and
receiving, at the DU (504), a RRC setup complete message from the UE (502).

17. A user equipment (UE) (302) attached to a network comprising a plurality of network elements for managing radio resource control (RRC) setup time with a scheduling request (SR) grant, the UE (302) comprising:
a processor; and
a computer readable storage medium storing programming for execution by the processor, the programming including instructions to:
receive, from a distributed unit (DU) (304), a random access response (RAR) after sending a random access channel (RACH) request to the DU (304);
send, to the DU (304), a RRC set up request;
receive, from the DU (304), a medium access control (MAC) control element (CE), wherein the DU (304) is configured to send an initial uplink (UL) RRC message to a centralized unit (CU) (306) and wherein the CU (306) is configured to send a downlink (DL) RRC message to the DU (304);
send, to the DU (304), a hybrid automatic repeat request (HARQ) feedback message;
receive, from the DU (304), a DL common control channel (CCCH) message;
send, to the DU (304), an uplink control information (UCI) indication message;
receive, from the DU (304), the scheduling request (SR) grant with modulation and coding scheme (MCS) and resource blocks (RBs); and
send, to the DU (304), a RRC setup complete message.

18. A user equipment (UE) (502) attached to a network comprising a plurality of network elements for a scheduling request (SR) proactive grant, the UE (502) comprising:
a processor; and
a computer readable storage medium storing programming for execution by the processor, the programming including instructions to:
receive, from a distributed unit (DU) (504), a random access response (RAR) after sending a random access channel (RACH) request to the DU (504);
send, to the DU (504), a RRC set up request;
receive, from the DU (504), a medium access control (MAC) control element (CE), wherein the DU (504) is configured to send an initial uplink (UL) RRC message to a centralized unit (CU) (506) and wherein the CU (506) is configured to send a downlink (DL) RRC message to the DU (504);
send, to the DU (504), a hybrid automatic repeat request (HARQ) feedback message;
receive, from the DU (504), a DL common control channel (CCCH) message;
allocate, by the DU (504), a plurality of resources for transmission of at least one message from the UE (502);
receive, from the DU (504), the SR proactive grant; and
send, to the DU (504), a RRC setup complete message.
